(19) United States
(12) Patent Application Publication
(10) Pub. No.: US 2006/0213719 A1
(43) Pub. Date: Sep. 28, 2006

(54) Compressor muffler with check valve

(75) Inventors: Erik Schlussler, Miami, FL (US); Anibal Guarderas, Miami, FL (US); Robert Zaballa, Hialeah, FL (US); David I. Liberty, Syracuse, NY (US)

Correspondence Address: CARLSON, GASKEY & OLDS, P.C., 400 WEST MAPLE ROAD, SUITE 350, BIRMINGHAM, MI, 48009, US

(73) Assignee: A-1 Components, Corp.

(21) Appl. No.: 11/088,525

(22) Filed: Mar. 24, 2005

(51) Int. Cl. F01N 1/16; F16K 17/00

(52) U.S. Cl. 181/237

(57) ABSTRACT

A muffler assembly for use in an air conditioning system includes a muffler conduit for receiving pressurized fluid and a valve in fluid communication with the muffler conduit. The valve is moveable between closed and open positions in response to a pressure differential in the muffler conduit. In one example, the valve includes a valve member and a magnetic member that magnetically influences movement of the valve member. In one example method of making a muffler assembly, the valve is arranged at least partially within the muffler conduit. The conduit includes first and second tube portions that are formed in a spinning operation.

### BACKGROUND OF THE INVENTION

This invention relates to a muffler and, more particularly, to a compressor muffler.

Commercial, residential and other air conditioning systems typically utilize a refrigerant to cool a space. A compressor pumps refrigerant gas to a condenser that permits the refrigerant gas to release heat to the surrounding environment as the refrigerant gas condenses (typically outdoors). Condensed refrigerant liquid circulates from the condenser to an evaporator (typically indoors). The refrigerant liquid expands within the evaporator and absorbs heat from air blowing over the evaporator. The refrigerant then circulates to the compressor and another cooling cycle begins.

Typical air conditioning systems produce surges in refrigerant flow through the air conditioning system. A surge in refrigerant flow may occur because of cyclic variation in a discharge pressure of the refrigerant from the compressor. The variation in flow may cause undesirable noise and fluctuation in the cooling capacity of the air conditioning system.

Disadvantageously, the air conditioning system may operate inefficiently because of refrigerant pressure loss. The pressure within the air conditioning system equalizes through a bleed valve near the compressor when the air conditioning system is shut off after operating for a time. When the air conditioning system is activated, the compressor operates for a period of time before there is enough build-up of refrigerant pressure to fully circulate the refrigerant through the air conditioning system. The compressor is operating but the air blowing over the evaporator may not be adequately cooled under this inefficient condition.

Accordingly, there is a need for an assembly that muffles the surge in refrigerant flow and reduces refrigerant pressure loss. This invention addresses those needs and provides enhanced capabilities while avoiding the shortcomings and drawbacks of the prior art.

### SUMMARY OF THE INVENTION

A muffler assembly for use in an air conditioning system includes a muffler conduit for receiving the pressurized fluid and a valve in fluid communication with the muffler conduit. The valve is moveable between a closed position and an open position in response to a pressure differential in the muffler conduit.

In one example, the valve includes a valve member and a magnetic member that magnetically influences movement of the valve member. The magnetic member biases the valve member to a closed position. The valve member is moved to an open position by the pressurized fluid when the pressure is great enough to overcome the magnetic attraction between the magnetic member and the valve member.

In one example method of making the muffler assembly, the valve is arranged at least partially within the conduit. In one example, the conduit includes a tube that undergoes a spinning operation to form a tube end portion.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 schematically shows selected portions of an air conditioning system.

FIG. 2 schematically shows selected portions of an example muffler assembly.

FIG. 3 schematically shows selected portions of an example muffler assembly having a valve in an open position.

FIG. 4 shows a perspective view of an example guide member of a valve of a muffler assembly.

FIG. 5 schematically shows a cross-section of selected portions of a muffler assembly.

FIG. 6 schematically shows selected portions of a muffler assembly during an example fabrication operation.

FIG. 7 schematically shows selected portions of a muffler assembly during an example fabrication operation.

### DETAILED DESCRIPTION OF THE PREFERRED EMBODIMENT

FIG. 1 schematically shows selected portions of an example air conditioning system 10. The air conditioning system 10 includes a compressor 12 that pumps refrigerant through air conditioning lines 14 to a muffler assembly 16. The muffler assembly 16 dampens surges of refrigerant flow from the compressor and a valve assembly 18 within the muffler assembly 16 prevents backflow of refrigerant into the compressor 12. Refrigerant from the muffler assembly 16 is received in a condenser 20 that permits the refrigerant to release heat to the surrounding environment (e.g., outdoors). Condensed refrigerant circulates from the condenser 20 through an expansion device 23 and then to an evaporator 22. The refrigerant expands in the evaporator 22 and absorbs heat from air blowing over the evaporator 22 to provide cool air to a space 24, such as an office, residency, or other space. The refrigerant then circulates to the compressor 12 and another cooling cycle beings.

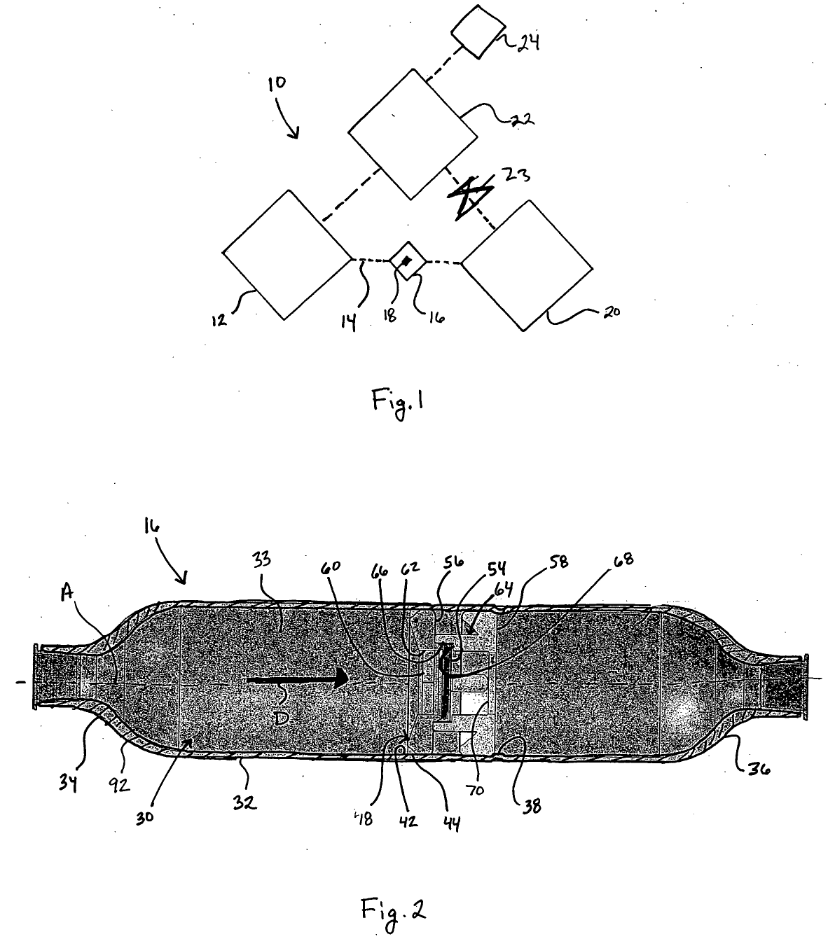

FIG. 2 shows selected portions of an example muffler assembly 16 including a muffler conduit 30 through which the refrigerant flows. The muffler conduit 30 includes a tube 32 having a mixing portion 33, an inlet tube portion 34 for receiving refrigerant from the compressor 12, and an outlet tube portion 36 leading to the condenser 20. In the example shown, the tube 32 has a larger cross-sectional area than the inlet tube portion 34 to promote mixing of the refrigerant and equalization of surge flow in the mixing portion 33.

The mixing portion 33 is of adequate volumetric size to equalize (i.e. muffle) surges of refrigerant flow from the compressor 12. That is, surges of flow are mixed in the mixing portion 33 to form a more uniform flow of refrigerant. In one example, the extent to which the surges of flow are mixed in the mixing portion 33 depends on the volume of the mixing portion 33. A smaller volume allows less mixing than a larger volume.

In the illustrated example, the tube 32 includes dimples 38 that extend inwardly from the tube 32. The valve assembly 18 abuts the dimples 38 such that the valve assembly 18 is prevented from moving axially past the dimples 38. The dimples 38 provide the benefit of at least partially securing the valve assembly 18 in the tube 32 without additional fastening operations, such as bolt tightening.

In the illustrated example, a seat member 56 of the valve assembly 18 is secured to an inner surface 42 of the tube 32 at a soldered joint 44. In one example, the seat member 56 is positioned in the tube 32 and solder material is deposited into the soldered joint 44 to secure the seat member 56 to the inner surface 42. The solder material forms a seal between the valve assembly 18 and the inner surface 42.

The valve assembly 18 includes a valve member 54 that moves between the seat member 56 and a guide member 58 in response to a pressure differential of the refrigerant across the valve assembly 18, as will be described in more detail below. The seat member 56 includes a magnet 60 that is press-fit into an opening 62, for example. In the example shown, the magnet 60 occupies less than a full cross-sectional area of the opening 62 such that refrigerant is permitted to flow through the opening 62 when the valve member 54 is open. The valve member 54 and guide member 58 are installed into the tube 32 and assembled to the seat member 56 after the seat member 56 is soldered.

The magnet 60 magnetically attracts the valve member 54 such that the valve member 54 is biased to a closed position sealed against the seat member 56. To move the valve member to an open position, a pressure of refrigerant in the mixing portion 33 overcomes the magnetic attraction and a pressure of refrigerant downstream of the valve assembly 18. In one example, the downstream refrigerant pressure is greater than the magnetic attraction such that the refrigerant pressure in the mixing portion 33 primarily overcomes the downstream refrigerant pressure to open the valve member 54.

In the illustrated example, the valve member 54 is made of a ferrous material that is subject to the magnetic influence of the magnet 60. This feature provides the advantage of attracting undesirable ferrous particles that are in the refrigerant, essentially removing the ferrous particles from the flow of refrigerant through the air conditioning system 10. Given this disclosure, those of ordinary skill in the art will recognize additional configurations that utilize magnetic influence to control movement of a valve member to meet their particular needs.

In the closed position, a pressure of refrigerant in the mixing portion 33 of the muffler assembly 16 is too low to overcome the downstream refrigerant pressure and the magnetic attraction between the magnet 60 and the valve member 54. Thus the refrigerant is prevented from flowing back into the compressor 12 from the condenser 20 and evaporator 22. In one example, this condition corresponds to the compressor being in an inactive state such that no refrigerant is being pumped from the compressor 12 to the muffler assembly 16.

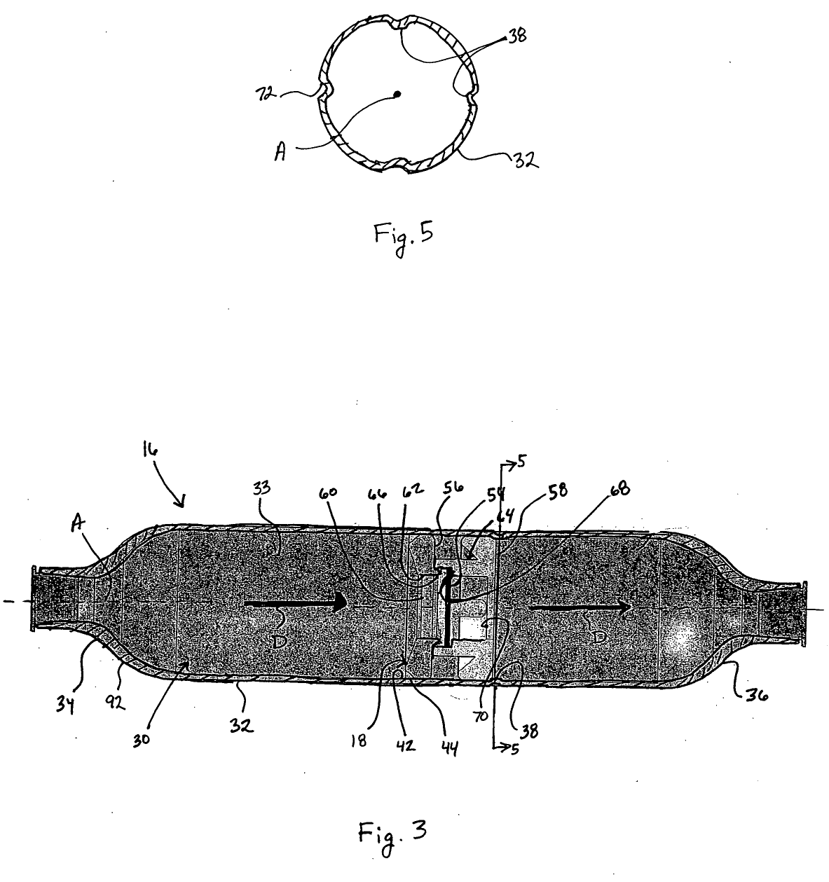

In another example, the compressor 12 has just been activated but has not yet built up enough pressure in the mixing portion 33 to overcome the downstream refrigerant pressure and magnetic attraction to move the valve member 54 to an open position. This may provide the benefit of increased efficiency of the air conditioning system 10 compared to previously known systems. In previously known systems, a compressor has to build the refrigerant pressure in the entire volume of the air conditioning system to fully circulate the refrigerant. In the disclosed example, the valve assembly 18 prevents refrigerant from backflowing into the compressor 12 from the condenser 20 and the evaporator 22. This in turn prevents refrigerant pressure loss through a bleed valve commonly located near the compressor 12 and prevents the compressor 12 from operating in reverse to expand the refrigerant. In the disclosed example, the compressor 12 only has to build the refrigerant pressure in the volume between the compressor 12 and the valve assembly 18 (i.e. less than the entire volume of the air conditioner system 10) in order to overcome the magnetic attraction and refrigerant pressure downstream from the valve assembly 18 to move the valve member 54 to an open position (FIG. 3) to fully circulate the refrigerant.

In the illustrated example, the guide member 58 includes spaced apart guide arms 64 that extend about the valve member 54. Each of the spaced apart guide arms 64 includes a first face 66 that restricts movement of the valve member 54 in a radial direction with respect to a central axis A and a second face 68 that restricts axial movement of the valve member 54. The guide arms 64 provide the advantage of maintaining alignment of the valve member 54 with the opening 62 of the seat member 56.

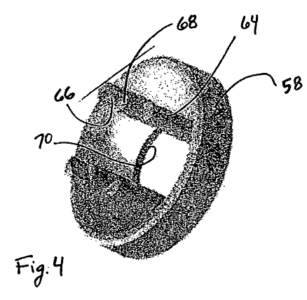

In the example shown, the spaced apart guide arms 64 mix the refrigerant as the refrigerant flows through the valve assembly 18. The refrigerant flows in a tortuous path through the opening 62, around the valve member 54 in a direction radial to the central axis A, between the spaced apart guide arms 64, and then again along the direction D out of an opening 70 (FIG. 4) in the guide member 58 to the outlet tube portion 36.

FIG. 5 schematically illustrates another cross-sectional view of an example tube 32. In the illustrated example, the dimples 38 are formed at 90° intervals around the circumference of the tube 32 to provide balanced support of the valve assembly 18. In one example, the dimples 38 are mechanically pressed into the tube 32 such that depressions 72 are left on the outside of the tube 32. In another example, the valve assembly 18 is welded to the inner surface 44 of the tube 32 before forming the dimples 38. The valve assembly 18 provides support of the tube 32 during the dimple forming process such that the walls of the tube 32 are prevented from buckling while the tube 32 is secured to form the dimples 38.

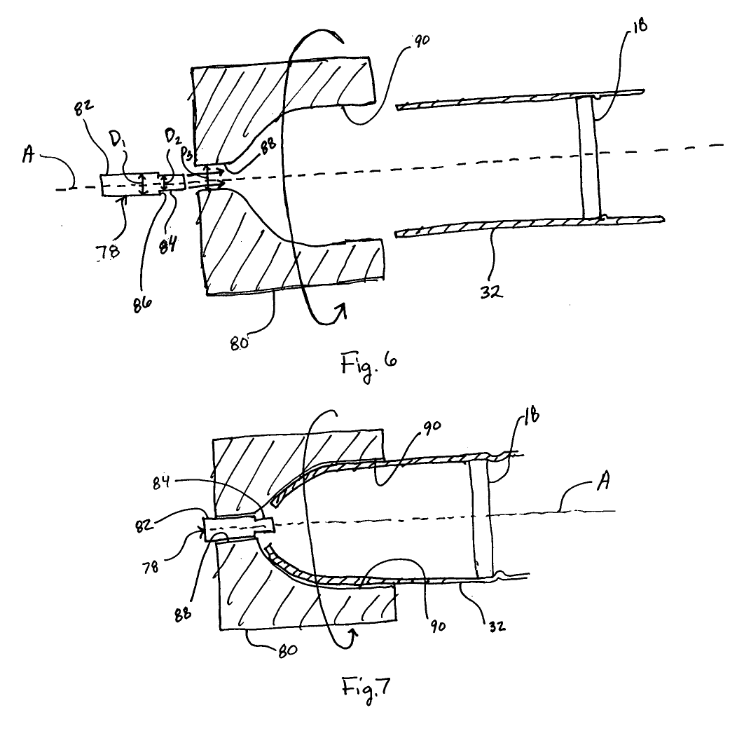

FIG. 6 schematically illustrates a method of making the muffler assembly 16. In the illustrated example, the valve assembly 18 is installed into the tube 32 before forming the inlet tube portion 34. This provides the benefit of allowing easier access to install the valve assembly 18 within the tube 32 rather than having to tediously install the valve assembly 18 through restrictive openings.

In one example forming operation, a pilot member 78 is inserted along the central axis A into a tool 80. The pilot member 78 includes a body portion 82 having a nominal dimension D₁ and an extended portion 84 having a smaller nominal dimension D₂. The body portion 82 and extended portion 84 form a lip 86. The nominal dimension D₁ corresponds to an inner diameter D₃ of an opening 88 of the tool 80 such that the pilot member 78 fits tightly within the opening 88.

The tube 32 is aligned along the central axis A and the tool 80 and pilot member 78 are rotated (i.e., spun) about the central axis A. The tube 32 is then inserted into a cavity 90 of the tool 80, as illustrated in FIG. 7. The tube 32 contacts the walls of the tool 80 that form the cavity 90. The contact produces friction and heats the tube 32. In the illustrated example, the tube 32 is heated to a temperature below the melting point of the tube 32 but high enough to make the tube 32 ductile such that continuing force on the tube 32 into the cavity 90 causes the tube 32 to bend inwardly over the extended portion 84 to form the inlet tube portion 34. As the tube 32 is further inserted into the cavity 90 and inwardly bent over the extended portion 84, the tube 32 contacts the lip 86. The lip 86 stops further advancement of the tube 32 into the cavity 90.

In one example, the tube 32 is made of a metal or metal alloy. The mechanical force of bending the tube 32 onto the extended portion 84 mechanically forms a thickened neck 92 between the inlet tube portion 34 and the tube 32.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A muffler assembly comprising:
a muffler conduit for receiving a pressurized fluid;
a valve in fluid communication with the muffler conduit, the valve being moveable between a closed position and an open position in response to a pressure differential in the muffler conduit.

2. The assembly as recited in claim 1, wherein the valve includes a valve member and a magnetic member, the valve member is moveable between the open position and the closed position, and the magnetic member magnetically influences movement of the valve member.

3. The assembly as recited in claim 1, wherein the muffler conduit includes a first tube portion and a second tube portion that is spin welded to the first tube portion.

4. The assembly as recited in claim 1, wherein the pressure differential corresponds to operation of a compressor.

5. The assembly as recited in claim 1, wherein the muffler conduit includes a pressurized fluid-mixing portion.

6. The assembly as recited in claim 1, wherein the muffler conduit includes an upstream first tube portion having a first cross-sectional area and a downstream second tube portion having a second cross-sectional area that is larger than the first cross-sectional area, with the valve received in the second tube portion.

7. The assembly as recited in claim 1, wherein the muffler conduit includes a tube portion having an inner surface and the valve is secured to the inner surface.

8. The assembly as recited in claim 1, wherein the muffler conduit includes a tube portion having an inner surface and a dimple extending from the inner surface.

9. The assembly as recited in claim 8, wherein the dimple at least partially secures the valve within the tube portion.

10. A muffler assembly comprising:
a muffler conduit for receiving a pressurized fluid;
a valve in fluid communication with the muffler conduit, the valve including a valve member that is moveable between a closed position and an open position in response to a fluid pressure differential in the muffler conduit; and
a magnetic member that magnetically influences movement of the valve member.

11. The assembly as recited in claim 10, wherein the valve includes a guide member that controls movement of the valve member in an axial direction and a radial direction relative to a central axis of the muffler conduit.

12. The assembly as recited in claim 10, wherein the valve includes a guide member having spaced apart guide arms that extend about a periphery of the valve member.

13. The assembly as recited in claim 10, wherein at least one of the magnetic member or the spaced apart guide arms direct flow of the pressurized fluid in a direction transverse to a central axis of the muffler conduit.

14. The assembly as recited in claim 10, wherein the magnetic member biases the valve member to the closed position.

15. The assembly as recited in claim 10, wherein the muffler conduit includes an upstream first tube portion having a first cross-sectional area and a downstream second tube portion having a second cross-sectional area that is larger than the first cross-sectional area, with the valve received in the second tube portion.

16. A method of making a muffler assembly comprising:
arranging a valve at least partially within a muffler conduit to control flow a pressurized fluid through the muffler conduit.

17. The method as recited in claim 16, including forming the muffler conduit with a first tube portion having a first nominal dimension and a second tube portion having a second, different nominal dimension.

18. The method as recited in claim 17, including rotating a tool about the first tube portion to frictionally heat the first tube portion.

19. The method as recited in claim 18, including bending the frictionally heated first tube portion inwardly to overlap a pilot portion of the tool to form the second tube portion.

20. The method as recited in claim 16, including securing the valve to an inner surface of the first tube portion.

21. The method as recited in claim 16, including forming at least one dimple within the first tube portion and arranging the valve adjacent to the at least one dimple.
